(19) United States
(12) Patent Application Publication
(10) Pub. No.: US 2019/0336917 A1
(43) Pub. Date: Nov. 7, 2019

(54) SYSTEM FOR AERATING A SUBMERGED MEMBRANE

(71) Applicant: SUEZ GROUPE, Paris La Defense Cedex (FR)

(72) Inventor: Chrystelle LANGLAIS, LURCY LEVIS (FR)

(21) Appl. No.: 16/475,023

(22) PCT Filed: Dec. 5, 2017
(86) PCT No.: PCT/EP2017/081582

§ 371 Date: Jun. 28, 2019

(30) Foreign Application Priority Data
Jan. 6, 2017 (FR) 1750140

(51) Int. Cl. B01D 65/02; B01D 63/00; C02F 3/20; C02F 3/12; B05B 15/531

(52) U.S. Cl. CPC B01D 65/02; B01D 63/00; C02F 3/20; C02F 3/1273; B05B 15/531; C02F 2303/20; B01D 2313/26; B01D 2315/06; B01D 2321/185; C02F 2303/16; B01D 2313/18

(57) ABSTRACT

A system for aerating a submerged membrane is provided. The system includes: a device for supplying compressed air; at least one orifice for aerating the submerged membrane; a pipe for feeding air from the air supplying device to the at least one aeration orifice; a first valve for opening or closing an orifice between the pipe and the surrounding air; a pressure sensor configured to measure the pressure in the pipe. The system is configured to perform at least one iteration of an operation to evacuate solid materials from the pipe, the said evacuation including at least: stopping supplying compressed air in the pipe and opening the first valve, causing reduction of the pressure in and penetration of liquid into the pipe; closing the first valve and resuming supplying compressed air in the pipe causing an increase in the pressure in and expulsion of liquid from the pipe through the at least one aeration orifice. The system is characterized in that it includes a processor configured to receive pressure measurements from the said pressure sensor that are performed during the said evacuation operation and to detect an anomaly of the aeration system on the basis of a comparison of the pressure measurements and at least one pressure threshold higher than or equal to the hydrostatic pressure of the column of liquid.

### FIELD OF THE INVENTION

The present invention concerns the field of submerged membranes. The present invention more specifically concerns the prevention of clogging of submerged membrane aeration devices.

### PRIOR ART

Membranes termed “submerged” are well known to the person skilled in the art and enable filtration or clarification of effluents. The treatment of effluents may be performed either directly or in conjunction with a physico-chemical coagulation treatment and/or in conjunction with a biological treatment.

Submerged membranes are used in particular in the context of membrane bioreactors. Membrane bioreactors are used for example for the filtration of pollutants or of waste water.

The filtration of effluents by the membrane induces accumulation of materials on the filter surface and concentration of the retained materials in the vicinity of the membranes. This phenomenon is known as “sludging”.

This sludging phenomenon induces numerous negative effects: an increase in the energy cost of the installation, a reduction of the filtration hydraulic capacity, or even shutting down of the installation in the most critical cases. This phenomenon therefore leads to a reduction of the service life of the membranes. Washing the membranes may equally prove costly in terms of reagents and labor.

Preventing and/or mastering this phenomenon of concentration of material on the filter surface of the submerged membranes therefore represents a problem of primary importance for the operators of submerged membranes.

The technique termed “membrane air scouring” enables alleviation of this problem. This technique consists in blowing air from the bottom to the top of the membrane, to submit it to an air-liquid two-phase ascending current. That current may contain medium-size to large air bubbles and/or pocket flow (flow of liquid alternating with large gas pockets) and enables the following effect to be obtained:
creation of turbulence and circulation of the liquid around the membrane of air lift type around the membrane, in order to evacuate the material and to reduce the phenomenon of concentration of material in the membranes; here air lift type circulation is characterized by an upward movement of the air bubbles at the surface of the membrane; these air bubbles drive liquid from the bottom to the top of the membranes, which causes aspiration of less charged liquid at the base of the membranes; there is therefore created a renewal of the liquid and of the materials in suspension that it contains in the vicinity of the membranes;
generation of a circulation of liquid tangential to the surface of the membrane to limit the deposits on the filter surface, generating filtration of pseudo-tangential type;
creation of localized turbulence at the interface between the air bubble and the membrane by localized mini reductions of pressure under the bubble, in order to eliminate the material deposited on the membrane and/or to limit the deposition thereof;
mechanical agitation of the membranes to eliminate the materials that have accumulated on and been concentrated on the filter surface and in its near environment.

The membrane aeration technique therefore enables prevention of the sludging phenomenon, and therefore constitutes a critical function for the operation of submerged membranes, and represents a major technical and economic challenge for the operators of submerged membranes. Thus any malfunction of this aeration function imperatively involves halting filtration.

However, because of their submersion in a concentrated liquid medium with materials in suspension, these aeration devices become clogged over time. For example, on stopping the aeration installation materials, for example biological sludge, are able to penetrate into the device and prove difficult to evacuate afterwards. In the presence of air these materials trapped in the aeration device dry out in the pipe and/or in the diffuser of the aeration device, which makes their evacuation even more difficult.

This clogging of the air diffusers can prove problematic. In fact, it can lead to head losses in the aeration pipe and therefore to a reduction of the energy efficiency and an increase in the energy consumption of the device.

In extreme situations partial or complete blocking of the air diffusers leads to the complete stopping of aeration of the membranes above the blocked air diffusers. In the absence of aeration, there occurs a very rapid “build-up”, that is to say a rapid accumulation of materials that are concentrated and are progressively dehydrated in the vicinity of the membrane for which aeration has been stopped, whereas the water is evacuated by filtration.

Situations of complete blocking of the air diffusers impose immobilization of the filtration workshop for manual operations of washing the diffusers and/or the membranes that are time consuming and laborious. Moreover, these operations create a risk of physically damaging the membranes, consumption of reagents and, in the end, a risk of significant reduction of the service life of the membranes.

Membrane supplier operator manuals suggest monitoring the clogging of the air diffusers, in particular monitoring the increase in head losses in the air pipe. This solution consists in measuring the air pressure in the membrane aeration pipe with the aid of a pressure gauge and monitoring the increase in pressure over time. If said air pipe is provided with a pressure sensor, a variant consists in visually and/or automatically monitoring the curve of evolution of the pressure in the membrane aeration pipe.

In the event of excessive increase in pressure, clogging is probably present and a manual cleaning operation must be triggered. However, the sensitivity of the clogging measurement is limited, in particular by the natural variability of the pressure in the pipe, which depends inter alia on:
the air flow rate in the case of aeration at variable flow rate to reduce electrical power consumption;
the temperature of the air discharged into the air pipe;
the depth of water in the membrane reactor in the case of excessive marling of the depth of liquid in the membrane reactor.

The pressure signal therefore varies naturally, which reduces the ability of an operator to diagnose rapidly clogging of the air diffusers on the basis of curves of pressure in the air pipe in operation.

Moreover, this technique enables only detection of clogging already well begun of the pipes of the air diffusers before it is too late, but does not enable prevention of the formation of the clogging.

In order to prevent on the upstream side blocking of the air diffusers, the person skilled in the art is also aware of solutions enabling cleaning of the air diffusers based on wetting and evacuating materials retained in the air pipe.

A first solution consists in shutting down the installation completely and then injecting clean water into the air pipe in the direction of the diffusers in order to force the evacuation of the materials trapped in the air diffuser.

This solution has a number of disadvantages. Firstly, this operation has to be carried out manually, which generates costs and limits the frequency with which cleaning is carried out. Moreover, the effectiveness is limited, because the water will tend to flow naturally through the orifices that are not clogged rather than through the orifices that are blocked. This limits the cleaning of the blocked orifices. Finally, in this solution the materials tend to accumulate toward the end of the air pipes, rather than being evacuated via the orifices of small size. This can produce cumulative clogging of the ends of the aeration pipes.

A second solution consists in effecting a forced cleaning/water expulsion of the air diffusers, that is to say, successively:
forced localized flooding of the air diffusers and of the air pipe by lowering the pressure in the air pipe and/or venting said pipe to atmospheric pressure; the pressure in the air pipe therefore becomes lower than the hydrostatic pressure generated by the column of water and water from the column effects the flooding of the pipe;
water expulsion by rapidly raising the pressure in the air pipe to expel the water and the material from the pipe via the air diffusers.

Reducing and then increasing the pressure in the air pipe are generally performed by actuating valves configured to allow or to prevent the arrival of compressed air in the pipe and to allow or to prevent entry of air at atmospheric pressure into the pipe.

An advantage of this option is that the same pressure is exerted simultaneously on all of the orifices during the flooding phase.

Another advantage of this solution is that it may be performed automatically and on an industrial scale, in accordance with the following procedure:
localized halting of the supply of air to the pipe;
localized opening of a valve disposed on the aeration line to vent the pipe to atmospheric pressure;
then closing said valve and resuming aeration.

The disadvantage of this automated solution is that the flooding may be performed defectively in the event of malfunctioning of the valves.

Malfunctions may arise if for example:

partial and/or excessively slow opening of a valve does not enable sufficient flooding of the air pipes and reduces commensurately the volume of liquid expelled;
slow closure reduces the speed of expulsion of the liquid and therefore the effectiveness of the device, and even accelerates clogging of the air diffusers by forcing entry of materials into the air pipe;
a too short duration of flooding of the air pipe does not enable the necessary and sufficient wetting of the dried materials in the pipe to facilitate evacuation thereof.

If the flooding/water expulsion procedure is carried out automatically but without monitoring its effectiveness, the latter can be significantly reduced in the event of a malfunction. If the latter is not detected, it can prove critical for the functioning of the submerged membrane.

The forced flooding/water expulsion procedure may be supervised manually by an operator. However, the use of an operator to supervise the flooding/water expulsion operations has the following disadvantages:
labor costs,
monitoring cannot be carried out in real time,
a necessarily limited monitoring frequency, which delays detection of a malfunction,
a risk factor owing to the operator's assessment margin.

These factors limit the preventive nature of the forced flooding/water expulsion solution.

There is therefore a need for a system for aeration of membranes clogging of which is automatically prevented by forced flooding/water expulsion operations wherein any anomaly of the forced flooding/water expulsion system is detected automatically.

### SUMMARY OF THE INVENTION

To this end, the invention describes a system for aeration of a membrane submerged in a column of liquid, including: a device for supplying compressed air; at least one orifice for aeration of the submerged membrane; a pipe configured to feed air from the air supply device to the at least one aeration orifice; a first valve configured to open or to close an orifice between the pipe and the surrounding air; a pressure sensor configured to measure the pressure in the pipe; said system being configured to perform at least one iteration of an operation to evacuate solid materials from the pipe, said evacuation including at least: stopping the supply of compressed air in the pipe and opening the first valve, leading to a decrease in the pressure in and a penetration of liquid into the pipe; closing the first valve and resuming supplying compressed air in the pipe, leading to an increase of the pressure in and expulsion of liquid from the pipe via the at least one aeration orifice; said system being characterized in that it includes a processor configured to receive pressure measurements from said pressure sensor performed during said evacuation operation and to detect an anomaly of the aeration system on the basis of a comparison of the pressure measurements to at least one pressure threshold higher than or equal to the hydrostatic pressure of the liquid column.

The invention enables availability of the membrane installations to be guaranteed.

The invention enables the hydraulic filtering capacity of a submerged membrane to be maintained over time.

The invention enables the service life of the submerged membranes to be preserved.

The invention enables reduction of the operating cost of the submerged membranes.

The invention enables to increase or, at the least, to maintain a good energy efficiency of the membrane aeration devices and therefore to reduce their energy consumption.

The invention enables detection of clogging of the air diffusers without delay, and therefore enables triggering of the washing procedures as soon as clogging begins.

The invention enables detection of any anomaly in the use of the air diffuser washing procedure.

The invention will be described with reference to examples of membranes submerged in a column of water. However, the invention is not limited to the examples and may be applied to any column of liquid.

The submerged membrane aeration system advantageously includes at least one sensor sensing the height of liquid in the liquid column and said processor is advantageously configured to calculate said at least one pressure threshold higher than or equal to the hydrostatic pressure of the liquid column as a function of the height of the liquid column.

This feature enables adaptation of the pressure threshold to the hydrostatic pressure of the column of water when the height of the column of water varies, and therefore of provision of a more reliable test for determining if the pressure of the air in the pipe enables expulsion of water from the pipe.

Said at least one pressure threshold higher than or equal to the hydrostatic pressure of the liquid column is advantageously a first pressure threshold corresponding to an expected pressure in the pipe during the supply of compressed air.

This feature enables verification that the pressure in the pipe indeed corresponds to the expected pressure when supplying compressed air and that the air is able to escape appropriately,

Said processor is advantageously further configured to detect anomalies of the aeration system on the basis of a comparison of the pressure measurements to a second pressure threshold representing an expected pressure in the pipe following the first step of decreasing the pressure in the pipe.

This feature enables detection of a malfunction of the aeration system preventing sufficient reduction of the pressure in the aeration system and therefore sufficient flooding of the column of water.

The processor is advantageously configured to calculate: a first time representing the moment at which the pressure in the pipe becomes lower than the first pressure threshold following triggering stopping the supply of compressed air in the pipe and opening the first valve; a second time representing the moment at which the pressure in the pipe reaches the second pressure threshold following triggering stopping the supply of compressed air in the pipe and opening the first valve.

This feature enables identification of the beginning and the end of the phases of reducing the pressure in the pipe and of wetting of the pipe and therefore detection of anomalies linked to a malfunction of each of those phases.

The processor is advantageously configured to detect an anomaly if the difference between the second time and the first time is lower than a first duration threshold representing an expected maximum pressure reduction duration in the event of correct operation of the first valve and stopping supplying compressed air.

This feature enables identification of abnormal operation of the valves enabling supply of air and/or reduction of the pressure in the pipe.

The processor is advantageously configured to calculate a third time representing the moment at which the pressure in the pipe becomes higher than the second pressure threshold following triggering closing the first valve and resuming supplying compressed air in the pipe.

This feature enables determination of the limit time between the wetting and expulsion phases and thus detection of anomalies linked to each of those phases.

The processor is advantageously configured to detect an anomaly if the difference between the third time and the second time is lower than a second duration threshold representing an expected minimum pipe wetting time or higher than a third duration threshold representing an expected maximum pipe wetting time.

This feature enables detection of an anomaly of the air diffuser washing procedure owing to too short a wetting time.

The processor is advantageously configured to calculate a fourth time representing the moment at which the pressure in the pipe becomes higher than or equal to the first pressure threshold following triggering closing the first valve and resuming supplying compressed air in the pipe.

This feature enables detection of the moment from which aeration of the membrane resumes.

The processor is advantageously configured to detect an anomaly if the difference between the fourth time and the third time is lower than a fourth duration threshold representing an expected maximum duration of expulsion of water from the pipe.

This feature enables detection of an anomaly of the air diffuser washing procedure owing to too low a rate of evacuation of water.

The processor is advantageously configured to detect an anomaly if the pressure in the pipe exceeds a third pressure threshold higher than the first threshold.

This feature enables detection of critical clogging of the aeration system.

The processor is advantageously configured to detect an anomaly if the pressure in the pipe is lower than a fourth pressure threshold lower than the first threshold following resuming supplying compressed air in the pipe.

This feature enables identification of a critical membrane aeration problem owing to a non-functional valve.

The processor is advantageously configured, on each iteration of the operation to evacuate solid materials, to perform a series of tests comparing pressures in the pipe to pressure thresholds or durations to duration thresholds, wherein: each test generates an alert if it is validated and is associated with an alert level; at least one test, if validated, generates a critical level alert; in the event of a critical level alert, the processor is configured to generate stopping of the aeration system; in the case of stopping on a non-critical level alert, the execution of a new iteration of the operation to evacuate solid materials and of execution of the set of tests.

This feature enables identification of anomalies of the aeration system according to different levels of criticality and stopping of the aeration system only for the most critical anomalies. This feature also enables validation of the presence of non-critical anomalies thanks to the repetition of the procedures and tests if a first non-critical anomaly is detected.

The aeration system advantageously includes a second valve whose opening and closing respectively allow and prevent the arrival of compressed air in the pipe from the compressed air supply device and the supply of compressed air in the pipe is stopped by closing the second valve; the supply of compressed air in the pipe is resumed by opening the second valve.

This feature enables execution of a pipe cleaning procedure that is both effective and economic in terms of energy.

The invention also describes a method partly executable by a processor of evacuation of solid materials in a pipe of a system for aeration of a membrane submerged in a column of liquid, said method including: a first step of stopping supplying compressed air in the pipe and opening a first valve between the pipe and the surrounding air, leading to a decrease of the pressure in and penetration of liquid into the pipe; a second step of closing the first valve and resuming supplying compressed air in the pipe leading to an increase of the pressure in the pipe and expulsion of liquid from the pipe via at least one orifice for aeration of the submerged membrane; a third step of the processor receiving pressure measurements from a pressure sensor configured to measure the pressure in the pipe, said measurements being performed at least between the start of stopping supplying air and the end of resuming supplying air; a fourth step of said processor detecting an anomaly of the aeration system including comparison of the pressure measurements to at least one pressure threshold higher than or equal to the hydrostatic pressure of the liquid column.

The method advantageously includes a step of calculating said at least one pressure threshold higher than or equal to the hydrostatic pressure as a function of a height of the liquid column obtained from measurements from at least one sensor of the height of liquid in the liquid column.

This feature enables adaptation of the pressure threshold to the hydrostatic pressure of the water column when the height of the water column varies and therefore availability of a more reliable test for determining if the pressure of the air in the pipe enables expulsion of water from the pipe.

Said at least one pressure threshold higher than or equal to the hydrostatic pressure of the liquid column is a first pressure threshold corresponding to an expected pressure in the pipe during the supply of compressed air.

This feature enables verification that the pressure in the pipe indeed corresponds to the expected pressure when supplying compressed air and that the air is able to escape appropriately.

The fourth step of said processor detecting an anomaly of the aeration system includes comparison of the pressure measurements to a second pressure threshold representing an expected pressure in the pipe following the first step of stopping supplying compressed air in the pipe and opening a first valve between the pipe and the surrounding air, leading to a drop in the pressure in and penetration of liquid into the pipe.

This feature enables detection of a malfunction of the aeration system preventing sufficient reduction of the pressure in the aeration system and therefore sufficient flooding of the column of water.

The fourth step of said processor detecting an anomaly of the aeration system advantageously includes calculation: of a first time representing the moment at which the pressure in the pipe becomes lower than the first pressure threshold, following triggering stopping supplying compressed air in the pipe and opening the first valve; a second time representing the moment at which the pressure in the pipe reaches the second pressure threshold after triggering stopping supplying compressed air in the pipe and opening the first valve.

This feature enables identification of the beginning and the end of the phases of reducing the pressure in the pipe and of wetting the pipe and therefore detection of anomalies linked to a malfunction of each of those phases.

The fourth step of said processor detecting an anomaly of the aeration system includes detecting an anomaly if the difference between the second time and the first time is lower than a first duration threshold representing an expected maximum pressure reduction time in the case of correct operation of the first valve and stopping supplying compressed air.

This feature enables identification of abnormal operation of the valves enabling supply of air and/or reduction of the pressure in the pipe.

The fourth step of said processor detecting an anomaly of the aeration system advantageously includes calculation of a third time representing the moment at which the pressure in the pipe becomes higher than the second pressure threshold after triggering closing the first valve and resuming supplying compressed air in the pipe.

This feature enables determination of the limit time between the wetting and expulsion phases and thus detection of anomalies linked to each of those phases.

The fourth step of said processor detecting an anomaly of the aeration system advantageously includes detecting an anomaly if the difference between the third time and the second time is lower than a second duration threshold representing an expected minimum pipe wetting time or higher than a third duration threshold representing an expected maximum pipe wetting time.

This feature enables detection of an anomaly of the air diffuser washing procedure owing to too short a wetting time.

The fourth step of said processor detecting an anomaly of the aeration system advantageously includes calculating a fourth time representing the moment at which the pressure in the pipe becomes higher than or equal to the first pressure threshold following triggering of closing the first valve and resuming supplying compressed air in the pipe.

This feature enables detection of the moment from which aeration of the membrane resumes.

The fourth step of said processor detecting an anomaly of the aeration system advantageously includes detecting an anomaly if the difference between the fourth time and the third time is lower than a fourth duration threshold representing an expected maximum duration of expulsion of water from the pipe.

This feature enables detection of an anomaly of the air diffuser washing procedure owing to too low a rate of evacuation of water.

The fourth step of said processor detecting an anomaly of the aeration system advantageously includes detecting an anomaly if the pressure in the pipe exceeds a third pressure threshold higher than the first threshold.

This feature enables detection of critical clogging of the aeration system.

The fourth step of said processor detecting an anomaly of the aeration system advantageously includes detecting an anomaly if the pressure in the pipe is lower than a fourth pressure threshold lower than the first threshold following resuming supplying compressed air in the pipe.

This feature enables identification of a critical membrane aeration problem owing to a non-functional valve.

The method advantageously includes on each iteration of evacuation of solid materials executing a set of tests comparing pressures in the pipe to pressure thresholds or durations to duration thresholds, wherein: each test generates an alert if it is validated, and is associated with an alert level; at least one test, if validated, generates a critical level alert; in the event of a critical level alert, the method includes stopping the aeration system; in the event of stopping on an alert of non-critical level, the method includes the execution of a new iteration of the evacuation of solid materials and the execution of the set of tests.

This feature enables identification of anomalies of the aeration system according to different levels of criticality and stopping of the aeration system only for the most critical anomalies. This feature also enables validation of the presence of non-critical anomalies thanks to the repetition of the procedures and tests if a first non-critical anomaly is detected.

The stopping of supplying compressed air in the pipe is advantageously performed by closing a second valve the opening and closing of which respectively allow or prevent the arrival of compressed air in the pipe from the compressed air supply device; the resuming supplying compressed air in the pipe is performed by opening the second valve.

This feature enables execution of a pipe cleaning procedure that is both effective and economic in terms of energy.

The invention also describes a computer program including program code instructions recorded on a medium that can be read by a computer including a processor to evacuate solid materials from a pipe of a system for aeration of a membrane submerged in a column of liquid, said computer program including: computer-readable programming means for stopping supplying compressed air in the pipe and commanding opening of a first valve between the pipe and the surrounding air, leading to a decrease of the pressure in and penetration of liquid into the pipe; computer-readable programming means for commanding closing of the first valve and resuming supplying compressed air leading to an increase of the pressure in the pipe and expulsion of liquid from the pipe via the at least one orifice for the aeration of the submerged membrane; computer-readable programming means for receiving pressure measurements from said pressure sensor configured to measure the pressure in the pipe, said measurements being performed at least between the start of stopping supplying air and the end of resuming supplying air; computer-readable programming means for detecting an anomaly of the aeration system including comparison of the pressure measurements to at least one pressure threshold higher than or equal to the hydrostatic pressure of the liquid column.

### LIST OF FIGURES

Other features will become apparent on reading the following detailed description given by way of nonlimiting example with reference to the appended drawings which show:

FIGS. 1a and 1b, two examples of prior art submerged membrane aeration devices;

FIG. 2, a submerged membrane aeration system according to the invention;

FIGS. 3a and 3b, two examples of measuring pressure during an operation to evacuate solid materials from the pipe of a submerged membrane aeration system according to two embodiments of the invention;

FIG. 4, an example of a set of tests on pressure measurements and alarms generated in one embodiment of the invention;

FIGS. 5a, 5b, 5c, 5d, four examples of pressure signals that have or have not generated alarms in one embodiment of the invention;

FIG. 6, a submerged membrane aeration method according to the invention.

### DETAILED DESCRIPTION

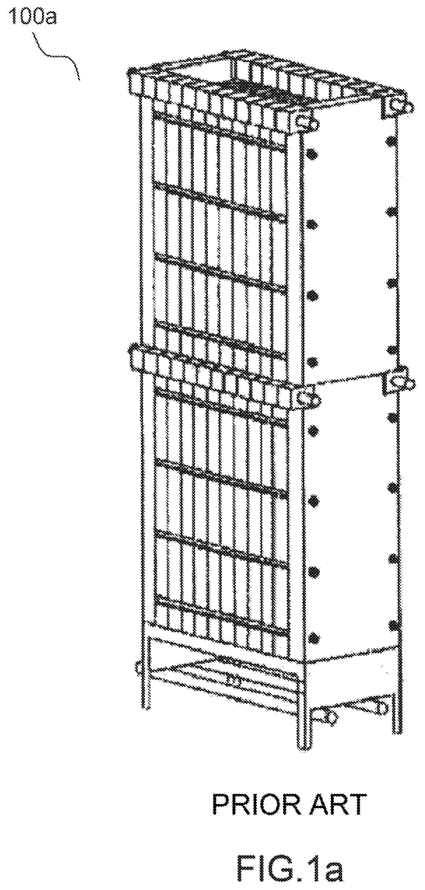

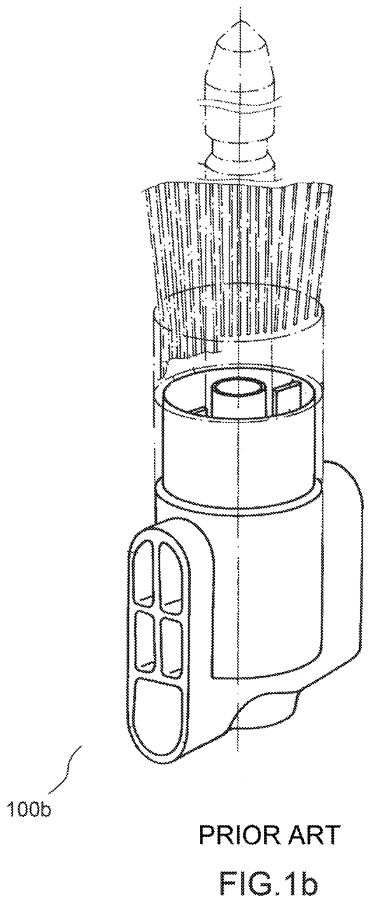

FIGS. 1a and 1b show two prior art submerged membrane aeration devices.

FIG. 1a shows a first prior art submerged membrane aeration device.

The device 100a is a simple device described in particular in patent application US 2015/353396. The device 100a consists of holes from a few millimeters to a few centimeters in diameter. The tubes are disposed under the membranes so that air bubbles that escape from them rise toward the membrane. The air bubbles therefore produce a two-phase flow enabling aeration of the membranes.

FIG. 1b represents a second prior art submerged membrane aeration device.

The device 100b is in particular described by the patent application DE 203 00546. In that device, the air orifices are incorporated in the membrane loading part in order for the injection of air to be performed as close as possible to the membranes.

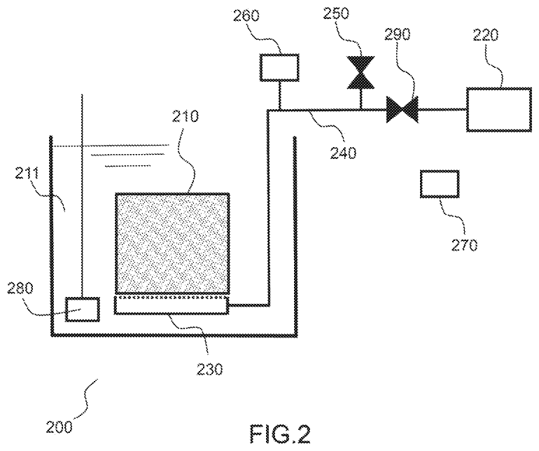

FIG. 2 shows a submerged membrane aeration system according to the invention.

The aeration system 200 enables aeration of at least one membrane 210 in a column of liquid. The system 200 includes a device 220 for supplying compressed air. The device 220 may for example be a compressor.

The device includes at least one submerged membrane aeration orifice 230 and a pipe 240 for feeding air from the compressed air supply device 220 to the at least one aeration orifice. The device 220 may supply air at a pressure higher than the hydrostatic pressure of the column at the level of the at least one orifice 230 so that air is able to escape from the at least one orifice 230 and aerate the membrane. This also makes it possible to avoid the pipe 240 being submerged during aeration of the membrane.

The at least one orifice 230 is preferably placed under the membrane 210, so that the air bubbles naturally rise from the orifice toward the membrane in order to aerate the latter. In one embodiment of the invention, a single orifice comprises the whole of a section of the pipe.

In some embodiments, the pipe has at its end an aeration device including a plurality of orifices. The size of the orifices then enables generation of larger or smaller air bubbles for aerating the membrane. The orifices may for example be circular orifices. The orifices may all have the same diameter or have different diameters. For example, the diameter of an orifice may be between approximately 2-3 mm and 1-1.5 cm inclusive. The orifices may be disposed at different locations on the perforated tubes, for example on top, on the bottom, or on the lateral parts of the latter. The invention is not limited to a shape or to dimensions of the orifices: the latter may have any shape and dimensions. The shapes and dimensions may be identical for all the orifices or vary within the aeration device.

The system 200 also includes a first valve 250 for opening or closing an orifice between the pipe and the surrounding air. Accordingly, when the first valve 250 is in the open position, the interior of the pipe 240 is in communication with the surrounding air. On the contrary, when the first valve 250 is in the closed position, the interior of the pipe 240 is in communication only with the device 220 for supplying compressed air and the liquid column 211.

The system 220 also includes a pressure sensor 260 configured to measure the pressure in the pipe. The pressure sensor may be placed anywhere in the pipe. In one embodiment of the invention, the pressure sensor 260 is placed above the upper limit of the liquid column 211 so that, when the pipe 240 is flooded, the liquid does not reach the pressure sensor 260, and the latter measures continuously the pressure of the air in the pipe 240.

The system 200 is configured to perform at least one iteration of an operation to evacuate solid materials from the pipe.

The operation to evacuate solid materials from the pipe includes a first step of stopping supplying compressed air in the pipe and opening the first valve 250.

In a first embodiment of the invention, supplying compressed air is stopped by stopping the operation of the device 220 for supplying compressed air. In another embodiment of the invention, the aeration system 220 includes a second valve 290 opening and closing of which respectively allow and prevent the arrival of compressed air in the pipe from the compressed air supply device and supplying compressed air in the pipe is stopped by closing the second valve. The second valve 290 may for example be situated at the outlet of the compressed air supply device.

In one embodiment of the invention, stopping the supply of compressed air in the pipe and opening the first valve 250 are performed simultaneously. In another embodiment of the invention, they are performed sequentially, for example by stopping supplying compressed air and then opening the first valve 250, or vice-versa.

Stopping supplying air and opening the first valve 250 enable rapid reduction of the pressure in the pipe to atmospheric pressure. In fact, in the absence of supplying compressed air, and with an open orifice between the pipe and the surrounding air, the compressed air present in the pipe is rapidly evacuated to the surrounding air. The pressure in the pipe 240 therefore decreases rapidly to atmospheric pressure.

The pressure in the pipe 240 therefore falls rapidly below the hydrostatic pressure of the liquid column 211. The liquid then penetrates into the pipe 240 via the at least one membrane aeration orifice 230. This penetration of liquid enables wetting of the solid materials that may have accumulated in the pipe 240 or at the level of the at least one aeration orifice 230.

The operation of evacuating solid materials from the pipe includes a second step of closing the first valve 250 and resuming supplying compressed air in the pipe.

In one embodiment of the invention, supplying compressed air is resumed by restarting operation of the compressed air supply device 220. In another embodiment of the invention, the aeration system 220 includes the second valve 290 and the supply of compressed air in the pipe is resumed by opening the second valve.

In one embodiment of the invention, resuming supplying compressed air in the pipe and closing the first valve 250 are performed simultaneously. In another embodiment of the invention, they are performed sequentially, for example by opening the first valve 250 and then stopping supplying compressed air, or vice-versa.

Resuming supplying air and closing the first valve 250 enable the pressure in the pipe 240 to increase rapidly. In fact, in the absence of communication between the pipe 240 and the surrounding air, the compressed air supply device enables a rapid increase in the pressure in the pipe 240.

The pressure in the pipe 240 therefore rises rapidly above the hydrostatic pressure of the liquid column 211. The liquid is then rapidly expelled from the pipe 240 via the at least one membrane aeration orifice 230. This rapid expulsion of liquid enables simultaneous evacuation of solid materials present in the pipe 240 or in the vicinity of the at least one aeration orifice 230 that have been wetted beforehand.

This kind of operation to evacuate solid materials, also known as forced flooding/water expulsion, enables automated evacuation at relatively low cost of solid materials that may have clogged the pipe 240.

The system 200 also includes a processor 270 configured to receive from said pressure sensor pressure measurements performed during said evacuation operation. In one embodiment of the invention the processor 270 and the pressure sensor 260 are located in the same device. In another embodiment of the invention the processor 270 is situated in a remote device, for example a remote workstation or a remote server, to which the pressure sensor is connected, and the measurements from the pressure sensor 260 are sent to the processor via a connection. The connection may be of any type, for example a cable connection, a radio connection or a wireless Internet data connection.

The processor 270 is configured to detect an anomaly of the aeration system 200 based on comparison of the pressure measurements to at least one pressure threshold higher than or equal to the hydrostatic pressure of the liquid column. More specifically, the at least one pressure threshold may be higher than or equal to the hydrostatic pressure of the liquid column at the level of the at least one orifice 230 to verify that the air in the pipe is at a sufficiently high pressure to escape from the pipe via the at least one orifice 230 and aerate the membrane. According to various embodiments of the invention, the at least one pressure threshold higher than or equal to the hydrostatic pressure of the liquid column may include a first pressure threshold P1 corresponding to an expected pressure in the pipe when supplying compressed air, a third pressure threshold PS1a lower than the first threshold P1, corresponding for example to an expected minimum pressure in the pipe 240 when supplying compressed air, or a fourth pressure threshold PS1b higher than the first threshold P1, corresponding for example to an expected maximum pressure in the pipe 240 when supplying compressed air.

The processor 270 is therefore configured to verify that the aeration system 200 is functional and that an iteration of the operation to evacuate solid materials from the pipe was performed correctly. It is therefore possible to detect without delay a malfunction of the operation to evacuate solid materials from the pipe and to implement curative operations before the pipe is completely clogged.

In one embodiment of the invention, the system 200 also includes at least one sensor 280 for sensing the height of the liquid column and the processor 270 is then configured to calculate said at least one pressure threshold higher than or equal to the hydrostatic pressure of the liquid column as a function of the height of the liquid column. The sensor 280 for sensing the height of the liquid column may for example be a sensor of the level indicating transmitter (LIT) type, which measures both the height of the liquid column and its hydrostatic pressure. In particular, the height of the liquid column enables calculation of the hydrostatic pressure at the level of the at least one orifice 230 for aeration of the submerged membrane and deduction therefrom of a pressure threshold higher than or equal to that hydrostatic pressure enabling expulsion of air from the pipe 240.

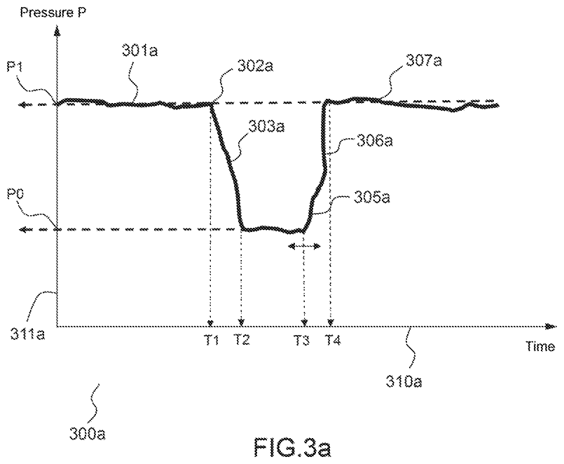

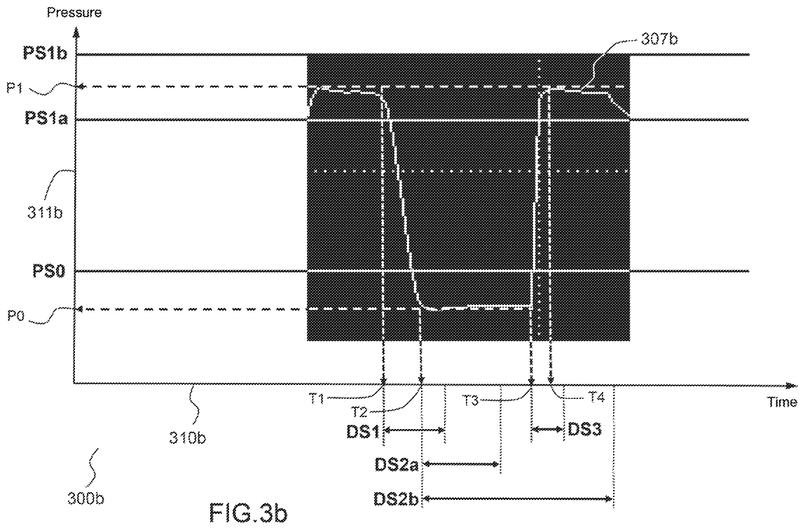

FIGS. 3a and 3b show two examples of pressure measurements during an operation to evacuate solid materials from the pipe of a submerged membrane aeration system according to two embodiments of the invention.

FIGS. 3a and 3b show two examples wherein the submerged membrane aeration system 200 functions appropriately and wherein no anomaly has occurred during the operation to evacuate solid materials from the pipe.

FIG. 3a shows a first example of pressure measurements during an operation to evacuate solid materials from the pipe of a submerged membrane aeration system 200 according to one embodiment of the invention.

The curve 300a shows the evolution over time of the pressure measured in a pipe 240 by a sensor 260 of a membrane aeration system 200 in one embodiment of the invention.

The horizontal axis 310a represents time and the vertical axis 311a the pressure in the pipe 240 measured by the sensor 260.

Before triggering the operation to evacuate solid materials from the conduit 240, the device 220 supplies compressed air and the first valve 250 is closed: the pressure of the air in the pipe 240 oscillates 301a about a high first pressure threshold P1. The pressure threshold P1 is higher than the hydrostatic pressure of the liquid column at the level of the at least one membrane aeration orifice 230. Air therefore flows through the at least one orifice 230 to aerate the membrane. In a set of embodiments of the invention, the first pressure threshold P1 is calculated as a function of a measured height of the liquid column. In some embodiments of the invention, the calculation of the first pressure threshold P1 may also take into account the head losses generated by the flow of air in the pipe 240.

The operation to evacuate solid materials then starts at 302a with stopping supplying air and opening the first valve 250. If the system 200 is operating normally, compressed air is evacuated by opening the first valve 250 and the pressure in the pipe 240 decreases rapidly at 303a to stabilize at 304a about a second pressure threshold P0 lower than P1. The second pressure threshold P0 is lower than the hydrostatic pressure of the liquid column at the level of the at least one membrane aeration orifice 230. The liquid can therefore enter into the pipe 240 and wet the solid materials in the pipe 240. In a set of embodiments of the invention, the second pressure threshold P0 corresponds to atmospheric pressure.

The pressure in the pipe 240 then begins to increase at 305a when the first valve 250 is closed and the supply of compressed air builds up. In the situation of normal operation of the system 200, the pressure in the pipe 240 increases suddenly at 306a. This sudden increase enables rapid evacuation in the liquid in the pipe 240 and evacuation of solid materials that have been wetted. The pressure then stabilizes at 307a around the first pressure threshold P1.

According to various embodiments of the invention, the procedure may have varying durations, varying for example as a function of the diameter of the pipe, the degree of clogging, etc. For example, the duration of the whole of the procedure may be of the order of about ten seconds and the duration of the pressure decrease 303a and the pressure increase 306a of the order of one second, or even one tenth of a second.

Throughout the operation the processor 270 receives measurements of the pressure in the pipe 240 and detects anomalies in the operation of the system based on comparisons of those measurements with at least one pressure threshold higher than or equal to the hydrostatic pressure of the liquid column, the first pressure threshold P1 in this example.

The processor 270 receives successive pressure measurements from the sensor 260. The measurements may be sent at regular intervals. For example, the processor 270 may receive a pressure measurement every millisecond.

In a set of embodiments of the invention, the processor 270 is also configured to detect anomalies of the system 200 based on a comparison of the pressure measurements to a second pressure threshold P0 expected following the first step of decreasing the pressure in the pipe 240.

In a set of embodiments of the invention, the processor 270 is configured to calculate a first time T1 representing the moment at which the pressure in the pipe becomes lower than the first pressure threshold, following triggering stopping supplying compressed air in the pipe and opening the first valve.

The first time T1 may be calculated in various ways. For example, the processor 270 may be configured to compare each pressure measurement to the first pressure threshold P1 from triggering the operation of decreasing the pressure in the pipe and calculate the time T1 as being the time of the first measurement lower than the first pressure threshold P1 after triggering the operation to decrease the pressure in the pipe. It is equally possible to calculate the time T1 as being the time of the first measurement lower than the first pressure threshold P1 lower than a predefined threshold after triggering the operation to decrease the pressure in the pipe. The processor 270 may equally be configured to calculate the derivative of the measured pressure and calculate the time T1 as being the first moment at which the absolute value of the derivative of the pressure is higher than a predefined threshold of pressure variation after triggering the operation to decrease the pressure in the pipe. The person skilled in the art can set up numerous different tests for determining the first time T1, in particular using the measurements of pressures in the pipe and/or derivatives thereof.

In a set of embodiments of the invention, the processor is configured to calculate a second time T2 representing the moment at which the pressure in the pipe reaches the second pressure threshold P0 following triggering stopping supplying compressed air in the pipe and opening the first valve.

In the same manner as for calculating the first time T1, numerous embodiments are possible for calculating the second time T2, in particular using the measurements of pressures in the pipe and/or their derivatives. The processor 270 may for example calculate the time T2 as being:
the first time at which the pressure becomes lower than or equal to the second pressure threshold P0 following triggering stopping supplying compressed air in the pipe and opening the first valve;
the first time at which the difference between the pressure and the threshold P1 becomes lower than a predefined threshold following triggering stopping supplying compressed air in the pipe and opening the first valve;
the first time at which the derivative of the pressure is lower than a pressure variation threshold and the difference between the measured pressure and the second pressure threshold P0 is lower than or equal to a predefined threshold.

The person skilled in the art may imagine any possible solution for determining the second time T2, for example by combining a number of the above criteria.

In a set of embodiments of the invention, the processor 270 is configured to calculate a third time T3 representing the moment at which the pressure in the pipe becomes higher than the second pressure threshold P0 following triggering closing the first valve and resuming supplying compressed air in the pipe.

In the same manner as for the calculation of the first time T1 and of the second time T2, numerous embodiments are possible for the calculation of the third time T3, in particular using the measurements of pressure in the pipe and/or their derivatives. The processor 270 may for example calculate the time T3 as being:
the first time at which the pressure becomes higher than the second pressure threshold P0 following triggering closing of the first valve and resuming supplying compressed air in the pipe;
the first time at which the difference between the pressure and the second pressure threshold P0 becomes higher than or equal to a predefined threshold following triggering of closing the first valve and resuming supplying compressed air in the pipe;
the first time at which the derivative of the pressure is higher than a pressure variation threshold following triggering closing the first valve and resuming supplying compressed air in the pipe.

The person skilled in the art may imagine any possible solution for determining the third time T3, for example by combining a number of the above criteria.

In a set of embodiments of the invention, the processor 270 is configured to calculate a fourth time T4 representing the moment at which the pressure in the pipe becomes higher than or equal to the first pressure threshold P1 following triggering closing the first valve and resuming supplying compressed air in the pipe.

In the same manner as for the calculation of the first time T1, the second time T2 and the third time T3, numerous embodiments are possible for the calculation of the fourth time 14, in particular using the measurements of pressures in the pipe and/or their derivatives. The processor 270 may for example calculate the time T4 as being:
the first time at which the pressure becomes higher than or equal to the first pressure threshold P1 following triggering closing the first valve and resuming supplying compressed air in the pipe;
the first time at which the difference between the pressure and the first pressure threshold P1 becomes lower than or equal to a predefined threshold following triggering closing the first valve and resuming supplying compressed air in the pipe;
the first time at which the derivative of the pressure is lower than a pressure variation threshold following triggering closing the first valve and resuming supplying compressed air in the pipe.

The person skilled in the art may imagine any possible solution for determining the fourth time T4, for example by combining a number of the above criteria.

FIG. 3b shows a second example of pressure measurements during an operation to evacuate solid materials from the pipe of a submerged membrane aeration system according to one embodiment of the invention.

The curve 300b shows the evolution over time of the pressure measured in a pipe 240 by a sensor 260 of a membrane aeration system according to one embodiment of the invention.

The horizontal axis 310b represents time and the vertical axis 311b the measured pressure.

The evolution of the pressure curve 300b as a function of time is very similar to that of the curve 300a.

Following the operation to evacuate solid materials, if the system is operating normally, the pressure 307b in the pipe is substantially equal to the first pressure threshold P1. However, the pressure may oscillate significantly about that value. In order to detect an anomaly of the system 200, the processor may be configured to detect if the pressure measurements exceed a third pressure threshold PS1b higher than the first pressure threshold P1. The processor may also be configured to detect if the pressure in the pipe is lower than a fourth pressure threshold PS1a lower than the first pressure threshold P1 following resuming supplying compressed air in the pipe. The third pressure threshold PS1a and the fourth pressure threshold PS1b may be chosen so as respectively to represent a minimum pressure and a maximum pressure expected in the pipe 240 when the device 220 is supplying compressed air and the first valve 250 is closed.

The values of the third pressure threshold PS1b and the fourth pressure threshold PS1a may be chosen so that an anomaly of the system is detected, but without generating a false alert, in the event of normal oscillation of the pressure measured in the pipe around the first pressure threshold P1. The values of the third pressure threshold PS1b and the fourth pressure threshold PS1a may for example be calculated by determining a maximum oscillation value expected in the pressure about the first pressure threshold P1 and by defining the third pressure threshold PS1b as being equal to the first pressure threshold P1 plus the expected maximum pressure oscillation value and the fourth pressure threshold PS1a as being equal to the first pressure threshold P1 minus the expected maximum pressure oscillation value. The expected maximum oscillation value of the pressure may be determined for example by observing the pressure measurements during normal operation of the system and reading off the maximum difference between the measured pressure and the first pressure threshold P1. The expected maximum pressure oscillation value may also be determined theoretically, taking into account local variations of the pressure in the pipe 240 and the expected variations in the operation of the compressed air supply device 220.

In some embodiments of the invention, the values of the third pressure threshold PS1b arid the fourth pressure threshold PS1a may be determined separately. All possible ways of calculating a third pressure threshold PS1b and a fourth pressure threshold PS1a representing expected minimum and maximum pressures following the operation to evacuate solid materials may be used for these embodiments of the invention.

In a set of embodiments of the invention, the processor may also be configured to detect anomalies by comparing differences between the first time T1, second time 12, third time T3, fourth time T4 and duration thresholds.

The processor 270 may for example be configured to detect an anomaly if the difference between the second time T2 and the first time T1 is lower than a first duration threshold DS1 representing an expected maximum pressure reduction duration in the case of correct operation of the first valve and stopping supplying compressed air.

It may again be configured to detect an anomaly if the difference between the third time T3 and the second time T2 is lower than a second duration threshold DS2a representing an expected minimum pipe wetting duration or higher than a third duration threshold DS2b representing an expected minimum pipe wetting duration.

It may again be configured to detect an anomaly if the difference between the fourth time T4 and the third time T3 is lower than a fourth duration threshold DS3 representing an expected maximum duration of expulsion of water from the pipe.

FIGS. 3a and 3b show a set of pressure thresholds, times and duration thresholds that may be used to detect an anomaly of the system 200. However, they are given merely by way of example. According to various embodiments of the invention, some or all of the pressure thresholds, times and duration thresholds shown in FIGS. 3a and 3b may be used to detect an anomaly of the system 200. In some embodiments of the invention other pressure thresholds, times, duration thresholds or any other data that can be determined from the pressure measurements or compared to the latter may be used.

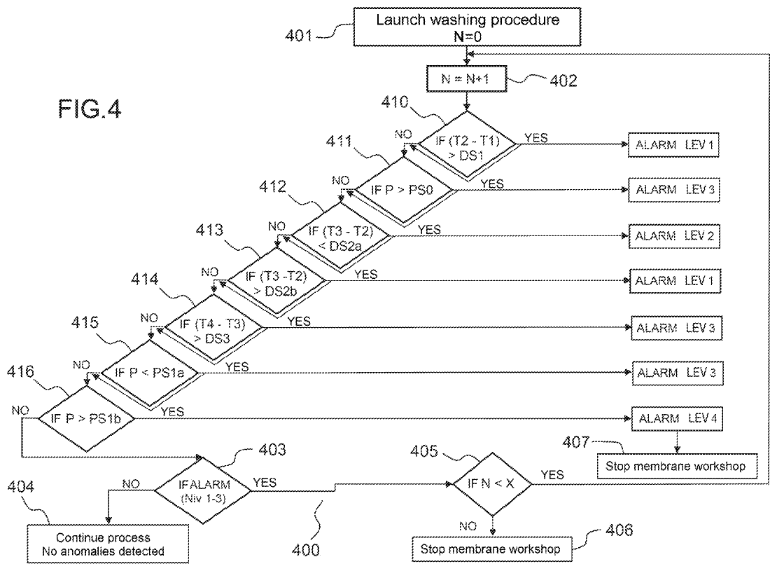

FIG. 4 shows one example of a set of tests on pressure measurements and alarms generated in one embodiment of the invention.

The set of tests 400 is performed by the processor 270 in a set of embodiments of the invention. The set of tests 400 is given by way of example only, according to different embodiments of the invention, and some or all of the tests from the set of tests 400 may be performed, and other tests may equally be performed.

The operation to evacuate solid materials may be performed in an iterative manner and the set of tests 400 according to the invention or any other set of tests may be performed on each iteration of the operation to evacuate solid materials.

In a set of embodiments of the invention, each test generates an alert if it is validated. The alerts may be classified according to a number of levels of gravity, including at least one critical level.

In the case of a critical level alert, an iteration of the operation to evacuate solid materials is not launched. Depending on the probable cause of the alert, a curative operation may be launched, if necessary with operation of the system 200 stopped temporarily to trigger a manual repair.

In the event of a non-critical alert, a new iteration of the operation to evacuate solid materials and a new execution of the set of tests 400 may be performed in order to verify if the alert is repeated or if it was an error. If the anomaly is detected again a repair operation may be triggered. According to different embodiments of the invention, different alerts or alert levels may be associated with a number N of successive detections, a repair operation being triggered only if the anomaly is detected N times successively. According to different embodiments of the invention and different anomalies, the number N of successive anomaly detections may be equal to 1, 2, 3, 4, 5 or any other number N making possible a compromise between correct operation of the system and prevention of an excessive number of repairs, depending on the gravity of the anomaly. The number N and the gravity associated with each test or anomaly may vary in different embodiments of the invention or systems according to the invention. It may equally be defined by each operator of a system 200 according to the invention.

In a set of embodiments of the invention, an iteration may be triggered immediately if at least one anomaly is detected, in order to resolve any ambiguity in the detection of the anomaly, and to trigger repairs as soon as possible. In a set of embodiments of the invention, the dates of the iterations of evacuation of solid material from the pipe and of execution of the tests are predefined and may for example occur at a regular frequency as long as a critical anomaly or a number N of successive non-critical anomalies have not been detected. In some embodiments of the invention, an iteration is performed at the end of a predefined time if a non-critical anomaly has been detected. Various embodiments are possible for defining the occurrence of the operations to evacuate solid materials and of execution of the tests, for example by combining one or more embodiments defined hereinafter.

In the example shown in the figure, the set of tests 400 is made up of 7 tests 410, 411, 412, 413, 414, 415, 416, and 417. If validated, each of these tests generates an error on a scale of criticality comprising 4 levels from 1 (least critical error) to 4 (critical error). In this example, the tests are based on comparisons between the pressure P measured by the pressure sensor 260 and the second pressure threshold PD, third pressure threshold PS1b, fourth pressure threshold PS1a defined in FIGS. 3a and 3b as well as comparisons between the first time T1, second time T2, third time T3, and fourth time T4 and the first duration threshold DS1, second duration threshold DS2, and third duration threshold DS3.

On initialization of the set of tests 100, washing of the membrane is first triggered at 401 and a number N of non-critical alerts is initialized at 402.

A procedure to evacuate solid materials from the pipe is then triggered. The set of tests 400 is performed on the pressure measurements performed by the sensor 260 during the washing procedure. The processor 270 may effect the tests on all the pressure measurements either during the procedure to evacuate solid materials, as and when the received pressure measurements enable the test to be performed, or following the procedure to evacuate solid material.

A first test 410 consists in comparing the difference between the second time T2 and the first time T1 to the first duration threshold DS1. If this difference is higher than the first threshold DS1, a level 1 alarm is generated. This alarm may be interpreted as a valve malfunction enabling supply of air and/or reduction of the pressure in the pipe, leading to an abnormally long pressure reduction in the pipe.

A second test 411 consists in comparing the pressure in the pipe 240 following reduction of the pressure to the second pressure threshold P0. If the pressure in the pipe 240 does not descend below the second pressure threshold P0, a level 3 alarm is generated. That alarm may be interpreted as a valve malfunction preventing sufficient reduction of the pressure in the aeration system and therefore sufficient flooding of the aeration device 230 and of the air pipe 240.

A third test 412 consists in comparing the difference between the third time T3 and the second time T2 to the second duration threshold DS2a. If that difference is lower than the second duration threshold DS2a, a level 2 alarm is generated. That alarm may be interpreted as a valve malfunction generating an anomaly of the procedure for washing the air diffusers owing to too short a wetting time.

A fourth test 413 consists in comparing the difference between the third time T3 and the second time T2 to the third duration threshold DS2b. if that difference is higher than the third duration threshold DS2b, a level 1 alarm is generated. That alarm may be interpreted as a valve malfunction allowing supply of air and/or increase of the pressure in the pipe, leading to an abnormally long time for starting the increase of the pressure in the pipe.

A fifth test 414 consists in comparing the difference between the fourth time T4 and the third time T3 to the fourth duration threshold DS3. If that difference is higher than the fourth duration threshold DS3, a level 3 alarm is generated. That alarm may be interpreted as an anomaly of the procedure for washing the air diffusers owing to a valve malfunction involving an insufficient rate of evacuation of water from the flooded air pipe.

A sixth test 415 consists in comparing the pressure P in the pipe 240 after the fourth time T4 or following the increase in the pressure in the pipe 240 to the fourth pressure threshold PS1a. If the pressure in the pipe 240 is lower than the fourth pressure threshold PS1a, a level 3 error is generated. This test enables detection of an abnormally low pressure in the pipe 240 that does not allow effective aeration of the membrane 210. This alarm may be interpreted as a valve malfunction or a malfunction of the air supply device 220 such that it is no longer supplying sufficient pressure in the pipe 240.

A seventh test 416 consists in comparing the pressure P in the pipe 240 after the fourth time T4 or following the increase in the pressure in the pipe 240 to the third pressure threshold PS1b. If the pressure in the pipe 240 is higher than the third pressure threshold PS1b, a level 4 critical error is generated. This test enables detection of a critical problem in aeration of the membrane owing to observed clogging of the aeration system 230. The processor 270 is then configured to trigger stopping of the membrane workshop at 407 in order to launch a corrective operation, avoiding a serious problem in the installation.

Following the set of tests 400, if no critical error has arisen, the processor 270 verifies at 403 whether non-critical errors have arisen. If no alarm has arisen, the aeration process continues normally at 404. If one or more errors has or have arisen, the processor 270 verifies at 405 if a maximum number of errors has been reached. If the maximum number of non-critical errors has been reached, the membrane workshop is stopped at 406 for repair. Otherwise, a new washing procedure is triggered, and a new iteration 402 of the set of tests is performed. This washing procedure therefore constitutes an ahead-of-time washing procedure and enables immediate verification whether the errors are reproduced. New iterations 402 of the washing procedure are therefore performed, either up to the absence of any alarm at 404 or up to shutting down the installation at 406 if the maximum number of errors is reached.

This example shows the capacity of the invention to enable definition of a battery of tests for detecting any anomaly of the system 200. However, the set of tests 400 is given by way of example only. Other sets of other tests can be carried out in other embodiments of the invention.

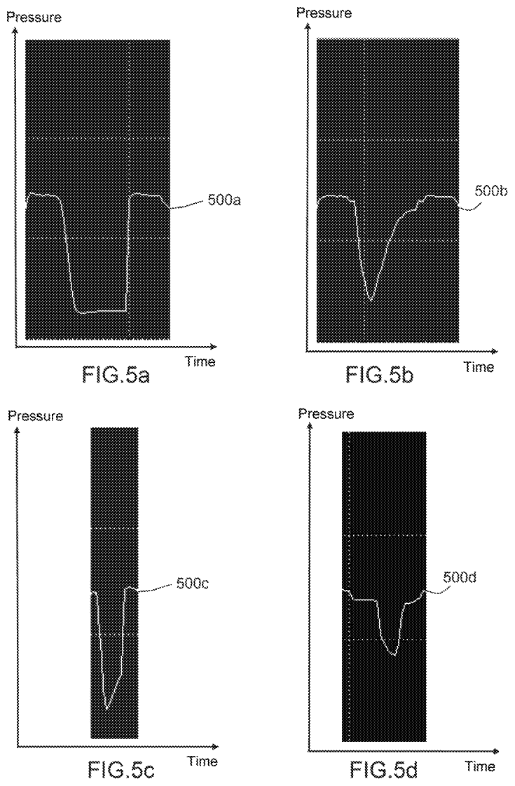

FIGS. 5a, 5b, 5c, 5d show four examples of pressure signals that do or do not generate alarms in one embodiment of the invention.

FIGS. 5a, 5b, 5c and 5d respectively show four pressure signals 500a, 500b, 500c and 500d representing the evolution of the pressure measured by the pressure sensor 260 as a function of time for four series of measurements.

FIG. 5a shows a first pressure signal 500a generated by a functional system in one embodiment of the invention. That signal is similar to the signals 300a and 300b and has not generated an alarm.

FIG. 5b shows a second pressure signal 500b generated by a malfunctioning system. In this example, the aeration system is malfunctioning: the pressure in the pipe decreases but does not reach the second pressure threshold P0. This anomaly can be detected by the system according to the invention, for example by the second test 411.

FIG. 5c shows a third pressure signal 500c generated by a malfunctioning system. In this example the pressure P in the pipe 240 decreases to a second threshold P0 but immediately increases again. The solid materials wetting time is therefore too short for the procedure to function normally. This anomaly can be detected by the invention, for example by the third test 412.

FIG. 5d shows a fourth pressure signal 500d generated by a malfunctioning system. In this example the aeration system is malfunctioning: the pressure in the pipe decreases but does not reach the second threshold P0. This anomaly can be detected by the invention, for example by the second test 411.

These examples show the capacity of a system according to the invention to detect various possible anomalies of a submerged membrane aeration system and to identify possible causes of anomalies and, where applicable, anticipate renewal of malfunctioning equipment identified early in this way (for example, the invention enables identification and replacement of a malfunctioning valve).

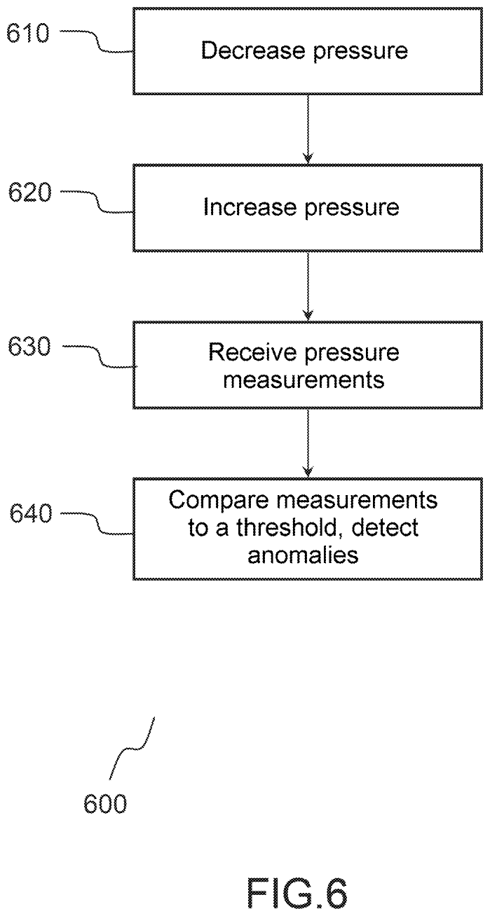

FIG. 6 shows a method according to the invention of aerating a submerged membrane.

The method 600 is a method of evacuation of solid materials from the pipe 240 of the system 200 for aerating a submerged membrane in a liquid column that can be executed in part by the processor 270. All the embodiments applicable to the system 200 are equally applicable to the method 600.

The method 600 includes a first step 610 of stopping supplying compressed air in the pipe and opening the at least one valve, leading to a reduction of the pressure in and penetration of liquid into the pipe.

The method 600 includes a second step 620 of closing the first valve and resuming supplying compressed air in the pipe, leading to an increase in the pressure in the pipe and expulsion of liquid from the pipe via the at least one aeration orifice.

The method 600 includes a third step 630 of a processor receiving pressure measurements from said pressure sensor performed at least between the start of stopping supplying air and the end of resuming supplying of air.

The method 600 includes a fourth step 640 of said processor detecting an anomaly of the aeration system including comparison of the pressure measurements to at least one pressure threshold higher than or equal to the hydrostatic pressure of the liquid column. The pressure threshold higher than or equal to the hydrostatic pressure of the liquid column may for example be the first threshold P1, the third threshold PS1a or the fourth threshold PS1b. In a set of embodiments of the invention the fourth step 640 of said processor detecting an anomaly of the aeration system may include some or all of the tests described with reference to FIGS. 3a, 3b and 4.

It should be noted that although the first, second, third and fourth steps are shown in that order in the FIG. 600, the order is not limiting on the invention and the steps of the method 600 may be performed in another order or in parallel. For example the third step 630 of the processor receiving pressure measurements may be performed as and when the measurements are performed, for example in parallel with the first step 610 and the second step 620. Likewise, the fourth step 640 of said processor detecting an anomaly may be performed progressively, each of the tests provided in the fourth step 640 being performed as soon as the measurements enabling it to be performed are available, in parallel with the first step 610, the second step 620 and the third step 630.

The above examples show the capacity of the invention to detect effectively malfunctions in a submerged membrane aeration system. They are given by way of example only however and in no case limit the scope of the invention, defined in the following claims.

1. A system for aeration of a membrane submerged in a column of liquid, including:
a device for supplying compressed air;
at least one orifice for aeration of the submerged membrane;
a pipe configured to feed air from the air supply device to the at least one aeration orifice;
a first valve configured to open or to close an orifice between the pipe and the surrounding air;
a pressure sensor configured to measure the pressure in the pipe;
said system being configured to perform at least one iteration of an operation to evacuate solid materials from the pipe, said evacuation including at least:
stopping the supply of compressed air in the pipe and opening the first valve, leading to a decrease in the pressure in and penetration of liquid into the pipe;
closing the first valve and resuming supplying compressed air in the pipe, leading to an increase of the pressure in and expulsion of liquid from the pipe via the at least one aeration orifice;
said system being wherein it includes a processor configured to receive pressure measurements from said pressure sensor performed during said evacuation operation and to detect an anomaly of the aeration system on the basis of a comparison of the pressure measurements to at least one pressure threshold higher than or equal to the hydrostatic pressure of the liquid column.

2. The system as claimed in claim 1 for aeration of a submerged membrane, including at least one sensor sensing the height of liquid in the liquid column and wherein said processor is configured to calculate said at least one pressure threshold higher than or equal to the hydrostatic pressure of the liquid column as a function of the height of the liquid column.

3. The system as claimed in claim 1 for aeration of a submerged membrane, wherein said at least one pressure threshold higher than or equal to the hydrostatic pressure of the liquid column is a first pressure threshold corresponding to an expected pressure in the pipe during the supply of compressed air.

4. The system as claimed in claim 1 for aeration of a submerged membrane, wherein said processor is further configured to detect anomalies of the aeration system on the basis of a comparison of the pressure measurements to a second pressure threshold representing an expected pressure in the pipe following the first step of decreasing the pressure in the pipe.

5. The aeration system as claimed in claim 4, wherein the processor is configured to calculate:
a first time representing the moment at which the pressure in the pipe becomes lower than the first pressure threshold following triggering stopping the supply of compressed air in the pipe and opening the first valve;
a second time representing the moment at which the pressure in the pipe reaches the second pressure threshold following triggering stopping the supply of compressed air in the pipe and opening the first valve.

6. The aeration system as claimed in claim 5, wherein the processor is configured to detect an anomaly if the difference between the second time and the first time is lower than a first duration threshold representing an expected maximum pressure reduction duration in the event of correct operation of the first valve and of stopping supplying compressed air.

7. The aeration system as claimed in claim 5, wherein the processor is configured to calculate a third time representing the moment at which the pressure in the pipe becomes higher than the second pressure threshold following triggering closing the first valve and resuming supplying compressed air in the pipe.

8. The aeration system as claimed in claim 7, wherein the processor is configured to detect an anomaly if the difference between the third time and the second time is lower than a second duration threshold representing an expected minimum pipe wetting time or higher than a third duration threshold representing an expected maximum pipe wetting time.

9. The aeration system as claimed in claim 7, wherein the processor is configured to calculate a fourth time representing the moment at which the pressure in the pipe becomes higher than or equal to the first pressure threshold following triggering closing the first valve and resuming supplying compressed air in the pipe.

10. The aeration system as claimed in claim 9, wherein the processor is configured to detect an anomaly if the difference between the fourth time and the third time is lower than a fourth duration threshold representing an expected maximum duration of expulsion of water from the pipe.

11. The aeration system as claimed in claim 5, wherein the processor is configured to detect an anomaly if the pressure in the pipe exceeds a third pressure threshold higher than the first threshold.

12. The aeration system as claimed in claim 5, wherein the processor is configured to detect an anomaly if the pressure in the pipe is lower than a fourth pressure threshold lower than the first threshold following resuming supplying compressed air in the pipe.

13. The aeration system as claimed in claim 5, wherein the processor is configured, on each iteration of the operation to evacuate solid materials, to perform a series of tests comparing pressures in the pipe to pressure thresholds or durations to duration thresholds, wherein:
each test generates an alert if it is validated and is associated with an alert level;
at least one test, if validated, generates a critical level alert;
in the event of a critical level alert, the processor is configured to generate stopping of the aeration system;
in the case of stopping on a non-critical level alert, the execution of a new iteration of the operation to evacuate solid materials and of execution of the set of tests.

14. The aeration system as claimed in claim 1, including a second valve the opening and closing of which respectively allow and prevent the arrival of compressed air in the pipe from the compressed air supply device, and wherein:
the supply of compressed air in the pipe is stopped by closing the second valve;
the supply of compressed air in the pipe is resumed by opening the second valve.

15. A method partly executable by a processor of evacuation of solid materials in a pipe of a system for aeration of a membrane submerged in a column of liquid, said method including:
a first step of stopping supplying compressed air in the pipe and opening a first valve between the pipe and the surrounding air, leading to a decrease of the pressure in and penetration of liquid into the pipe;
a second step of closing the first valve and resuming supplying compressed air in the pipe leading to an increase of the pressure in the pipe and expulsion of liquid from the pipe via at least one orifice for aeration of the submerged membrane;
a third step of the processor receiving pressure measurements from a pressure sensor configured to measure the pressure in the pipe, said measurements being performed at least between the start of stopping supplying air and the end of resuming supplying air;
a fourth step of said processor detecting an anomaly of the aeration system including comparison of the pressure measurements to at least one pressure threshold higher than or equal to the hydrostatic pressure of the liquid column.

16. A computer program product including program code instructions recorded on a medium that can be read by a computer including a processor to evacuate solid materials from a pipe of a system for aeration of a membrane submerged in a column of liquid, said computer program including:
computer-readable programming means for stopping supplying compressed air in the pipe and commanding opening of a first valve between the pipe and the surrounding air, leading to a decrease of the pressure in and penetration of liquid into the pipe;
computer-readable programming means for commanding closing of the first valve and resuming supplying compressed air leading to an increase of the pressure in the pipe and expulsion of liquid from the pipe via the at least one orifice for the aeration of the submerged membrane;
computer-readable programming means for receiving pressure measurements from said pressure sensor configured to measure the pressure in the pipe, said measurements being performed at least between the start of stopping supplying air and the end of resuming supplying air;
computer-readable programming means for detecting an anomaly of the aeration system including comparison of the pressure measurements to at least one pressure threshold higher than or equal to the hydrostatic pressure of the liquid column.
